(19) United States
(12) Patent Application Publication
(10) Pub. No.: US 2004/0128355 A1
(43) Pub. Date: Jul. 1, 2004

(54) Community-based message classification and self-amending system for a messaging system

(76) Inventors: Kuo-Jen Chao, Tainan Hsien (TW); Tu-Hsin Tsai, Taipei City (TW); Gen-Hung Su, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,184

(22) Filed: Dec. 25, 2002

(51) Int. Cl. G06F 15/16; H04L 9/32

(52) U.S. Cl. 709/206; 709/207; 713/201

(57) ABSTRACT

A server is provided with a classifier capable of assigning a classification confidence score to a message for at least one category. The server is further provided with a categorization database that contains a category sub-database for each category. The classifier utilizes the category database to assign the classification confidence scores. Clients are provided with forwarding modules that are capable of sending update messages to the server and associating the messages with at least one of the categories in the categorization database and a user profile. Initially, a first message is received at a client. The forwarding module is used to forward the first message to the server, and the first message is associated with a first category. A first category sub-database, which corresponds to the first category, in the categorization database is modified according to the first message and the user profile. When a second message is received at the server, the classifier is utilized to assign a classification confidence score to the second message corresponding to the first category according to the modified first category sub-database. Finally, a filtering technique is applied to the second message according to the classification confidence score.

### BACKGROUND OF THE INVENTION

1. Field of the Invention

The present invention relates to computer networks. More specifically, a system is disclosed that enables network users to update message classification and filtering characteristics based upon received messages.

2. Description of the Prior Art

To date, there exists a great deal of technology, both in terms of hardware but particularly in terms of software, that permit message categorizing and filtering in a networked environment. Special regard is made with the identification and blocking of electronic mail messages (e-mail) that contain malicious embedded instructions. Such malicious code is typically termed a “worm” or a “virus”, and the software that detects worms and viruses and other such types of unwanted and/or malicious code is generally called “anti-virus” software. The term virus is frequently used to indicate any type of unwanted and/or malicious code hidden in a file, and this terminology is adopted in the following. Anti-virus software is well known to almost anyone who uses a computer today, especially for those who frequently obtain data of dubious origin from the Internet.

U.S. Pat. No. 5,832,208 to Chen et al., included herein by reference, discloses one of the most widely used message filters applied to networks today. Chen et al. disclose anti-virus software disposed on a message server, which scans e-mail messages prior to forwarding them to their respective client destinations. If a virus is detected in an e-mail attachment, a variety of options may be performed, from immediately deleting the contaminated attachment, to forwarding the message to the client recipient with a warning flag so as to provide the client with adequate forewarning.

Please refer to FIG. 1. FIG. 1 is a simple block diagram of a server-side message filter applied to a network according to the prior art. A local area network (LAN) 10 includes a server 12 and clients 14. The clients 14 use the server 12 to send and receive e-mail. As such, the server 12 is a logical place to install an e-mail anti-virus scanner 16, as every e-mail message within the LAN 10 must vector through the server 12. As e-mails arrive from the Internet 20, they are initially logged by the server 12 and scanned by the anti-virus scanner 16 in a manner familiar to those in the art. Uninfected e-mails are forwarded to their respective destination clients 14. If an e-mail is found to be infected, a number of filtering techniques are available to the server 12 to handle the infected e-mail. A drastic measure is to immediately delete the infected e-mail, without forwarding to the destination client 14. The client 14 may be informed that an incoming e-mail was found to contain a virus and was deleted by the server 12. Alternatively, only the attachment contained within the e-mail that was found to be infected may be removed by the server 12, leaving the rest of the e-mail intact. The uninfected potion of the e-mail is then forwarded to the client 14. The most passive action on the part of the server 12, apart from doing nothing at all, is to insert a flag into the header (or even into the body portion) of an infected e-mail, indicating that a virus may potentially exist within the e-mail message. This augmented e-mail is then forwarded to the client 14. E-mail programs 14a on the client computers 14 are designed to look for such warning flags and provide the user with an appropriate warning message.

Many variations are possible to the arrangement depicted in FIG. 1, and there is no point in attempting to exhaustively iterate them all. One thing in common with all of these arrangements, however, is that the anti-virus scanner 16, wherever it may be installed, requires the use of a virus database 16a. The virus database 16a contains a vast number of virus signatures, each of which uniquely identifies a virus that is known to be “in the wild” (i.e., circulating about the Internet 20), and which can therefore be used to identify any incoming virus hidden within an e-mail attachment. Each signature should uniquely identify only its target virus, so as to keep false positive scans to a minimum. The virus database 16a is intimately linked with the anti-virus scanner 16, and is typically in a proprietary format that is determined by the manufacturer 22 of the anti-virus scanner 16. That is, neither the sysop of the server 12, nor users of the clients 14 can manually edit and update the virus database 16a. As almost every computer user knows, new viruses are constantly appearing in the wild. It is therefore necessary to regularly update the virus database 16a. Typically, this is done by connecting with the manufacturer 22 via the Internet 20 and downloading a most recent virus database 22a, which is provided and updated by the manufacturer 22. The most recent virus database 22a is used to update (“patch”) the virus database 16a. Employees at the manufacturer 22 spend their days (and possibly their nights) collecting viruses from the wild, analyzing them, and generating appropriate signature sequences for any new strains found. These new signatures are added to the most recent virus database 22a.

The above arrangement is not without its flaws. Consider the situation in which a so-called hacker 24 successfully develops a new strain of virus 24a. Feeling somewhat anti-social, the hacker 24 thereupon bulk mails the new virus 24a to any and all e-mail addresses known to that individual. Coming fresh from the lab as it were, there will be no virus signature for the new virus 24a in either the virus database 16a of the server 12, or in the most recent virus database 22a of the manufacturer 22. Several days, or even weeks, may pass by before the employees at the manufacturer 22 obtain a sample of the new virus 24a and are thus able to update their database 22a. Even more time may pass before the sysop of server 12 gets around to updating the virus database 16a with the most recent virus database 22a. This affords the new virus 24a sufficient time to infect a client 14 of the server 12. Worse still, there is no automated way for an infected client 14 to inform the anti-virus scanner 16 that an infection from the new strain of virus 24a has been detected. A subsequent e-mail, also infected with the new virus 24a, will just as easily pass through the anti-virus scanner 16 to infect another client 14, despite a user awareness of the new virus 24a. In short, word of mouth must be used within the LAN 10 in the interim between a first attack by the new virus 24a upon a client 14 and the updating of the virus database 16a with the appropriate signature of the new virus 24a. Word of mouth, however, is notoriously unreliable, and almost inevitably many other clients 14 will suffer from an attack by the new virus 24a.

Another type of e-mail message that warrants filtering is so-called “spam”. Spam is unsolicited e-mail, which is typically bulk mailed to thousands of recipients by an automated system. By some accounts, spam is responsible for nearly 60% of the total traffic of e-mail messages. Everyday, users find their mailboxes cluttered with spam, which is a source of genuine irritation. Beyond being merely irritating, spam can be passively destructive in that it can rapidly lead to e-mail account data storage limits being reached. When an e-mail inbox is filled with spam, legitimate correspondence can be lost; denied space by all of that unwanted spam. The manufacturer 22 generally does not even attempt to adapt the virus databases 16a and 22a to detect spam, though this is theoretically possible. After all, the same mechanism that can detect a virus can just as easily identify a particular piece of spam. The variability and sheer volume of spam, however, makes viruses appear to be almost rare in comparison. Attempting to track spam in a manner analogous to that used for virus attacks is simply too overwhelming a task for the manufacturer 22. Hence, spam flows freely and with impunity from the Internet 20 via the server 12 to the clients 14, despite the anti-virus scanner 16.

Buskirk et al., in U.S. Pat. No. 6,424,997, which is included herein by reference, disclose a machine learning based e-mail system. The system employs a classifier to categorize incoming messages and to perform various actions upon such messages based upon the category in which they are classed. Please refer to FIG. 2, which is a simplified block diagram of a classifier 30. The classifier 30 is used to class message data 31 into one of n categories by generating a confidence score 32 for each of the n categories. The category receiving the highest confidence score is generally the category into which the message data 31 is then classed. The internal functioning of the classifier 30 is beyond the intended scope of this invention, but is well known in the art. Buskirk et al. in U.S. Pat. No. 6,424,997 disclose some aspects of machine learning classification. U.S. Pat. No. 6,003,027 to John M. Prager, included herein by reference, discloses determining confidence scores in a categorization system. U.S. Pat. No. 6,072,904 to Ranjit Desai, included herein by reference, discloses image retrieval that is analogous to the categorization of images. Finally, U.S. Pat. No. 5,943,670, also to John M. Prager and included herein by reference, discloses determining whether the best category for an object is a mixture of preexisting categories. These are just some of numerous examples of categorization and machine learning systems that are available today. In general, though, almost all categorization is based upon the principle of using sample entries to define a class. To this end, the classifier 30 includes a categorization database 33. The categorization database 33 is divided into n sub-databases 34a-34n to define the n categories. The first category sub-database 34a holds sample entries 35a that are used to define the principle characteristics of a first category. Similarly, the n^{th} category sub-database 34n holds sample entries 35n that help to define an n^{th} category. Machine learning is effected by choosing the best samples 35a-35n that define their respective categories, creating classification “rules” based upon the samples 35a-35n. Typically, the greater the number of samples 35a-35n, the better the rules and the more accurate the analysis of the classifier 30 will be. It should be understood that the format of the sample entries 35a-35n may depend upon the type of classification engine used by the classifier 30, and may be raw or processed data.

The classifier 30, as used in the prior art, suffers some of the problems that plague the anti-virus scanner 16 of FIG. 1. In particular, the categorization database 33 may be in a proprietary format, and hence adding or changing sample entries 35a-35n may not be possible. Or, only a single user with special access privileges may be able to make modifications to the categorization database 33 by way of proprietary software that requires extensive training to use. No mechanism exists that enables a regular user in a network to provide data to the categorizations database 33 to serve as a sample entry 35a-35n, and hence a great deal of knowledge that may be available in a network to better help in the classification of messages is unutilized.

### SUMMARY OF THE INVENTION

It is therefore a primary objective of this invention to provide a community-based message categorization and filtering system that enables self-reporting of messages to augment subsequent categorization and filtering characteristics. In particular, it is an objective of this invention to enable any user in a network to report a previously unknown sample to another computer to enable that computer to subsequently categorize and filter messages similar to the sample. As another objective, the present invention seeks to rank users who provide such samples to prevent the submission of spurious information to ensure that samples in a categorization database are as reliable as possible.

Briefly summarized, the preferred embodiment of the present invention discloses a method and related system for categorizing and filtering messages in a computer network. The computer network includes a first computer in networked communications with a plurality of second computers. The first computer is provided with a classifier capable of assigning a classification confidence score to a message for at least one category. The first computer is further provided with a categorization database that contains a category sub-database for each category. The classifier utilizes the category database to assign the classification confidence scores. Each of the second computers is provided with a forwarding module that is capable of sending a message from the second computer to the first computer and associating the message so forwarded with at least one of the categories in the categorization database and with a user. Initially, a first message is received at one of the second computers. The forwarding module at the second computer is used to forward the first message to the first computer, and the first message is associated with a first category and with the user of the second computer. A first category sub-database, which corresponds to the first category, in the categorization database is modified according to the first message, and according to the user profile. A second message is then received at the first computer. The classifier is utilized to assign a first confidence score to the second message corresponding to the first category according to the modified first category sub-database. Finally, a filtering technique is applied to the second message according to the first confidence score.

It is an advantage of the present invention that it enables a user at any of the second computers to forward a message to the first computer, and associate that message as being an example of a certain categorization type, such as “spam”. The first computer utilizes a classifier to assign confidence levels to incoming messages as belonging to a certain category type. By enabling augmentation to the categorization database by any of the second computers, the first computer is able to learn and identify new types of category examples contained within incoming messages. In short, within a community of such interlinked computers, the knowledge of the community can be harnessed to identify and subsequently filter incoming messages.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a simple block diagram of a server-side message filter applied to a network according to the prior art.

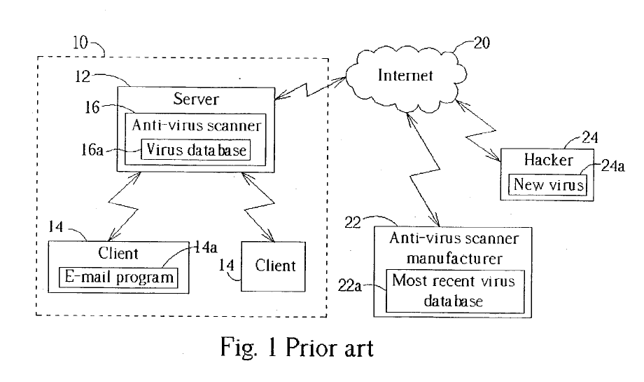

FIG. 2 is a simplified block diagram of a classifier.

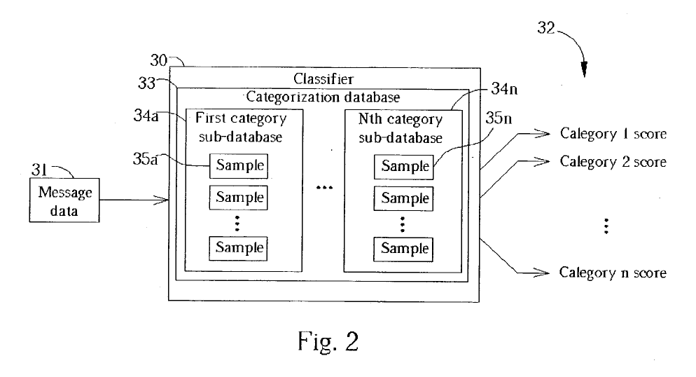

FIG. 3. is a simple block diagram of a network according to a first embodiment of the present invention.

FIG. 4. is a simple block diagram of a network according to a second embodiment of the present invention.

FIG. 5 is an block diagram illustrating a voting method of the present invention filtering system.

FIG. 6 is a simple block diagram of a network utilizing user ranking score attenuation according to the present invention.

FIG. 7 is a flow chart describing modification to a categorization sub-database according to the present invention.

### DETAILED DESCRIPTION

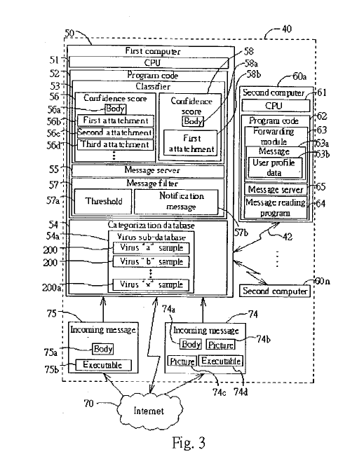

Please refer to FIG. 3. FIG. 3. is a simple block diagram of a network 40 according to a first embodiment of the present invention. The network 40 includes a first computer 50 in networked communications with a plurality of second computers 60a-60n via a network connection 42. For the sake of brevity, only the second computer 60a is shown with internal details, but such details are assumed present in all of the second computers 60a-60n. The networking of computers (i.e., the network connection 42) is well known in the art, and need not be expounded upon here. It should be noted, however, that for the purposes of the present invention the network connection 42 may be a wired or a wireless connection. The first computer 50 includes a central processing unit (CPU) 51 executing program code 52. The program code 52 includes various modules for implementing the present invention method. Similarly, each of the second computers 60a-60n contains a CPU 61 executing program code 62 with various modules for implementing the present invention method. Generating and using these various modules within the program code 52, 62 should be well within the abilities of one reasonably skilled in the art after reading the following details of the present invention. As a brief overview, it is the objective of the first embodiment to enable each of the second computers 60a-60n to inform the first computer 50 of a virus attack. It is assumed that the first computer 50 is a message server, and that the second computers 60a-60n are clients of the message server 50. The first computer 50 utilizes a classifier 53 to analyze an incoming message 74, such as an e-mail message, and supplies a classification confidence score that indicates the probability that the message 74 is a virus-containing message. Messages may come from the Internet 70, as shown by message 74, or may come from other computers within the network 40. The classifier 53 utilizes a categorization database 54 to perform the classification analysis upon the incoming message 74. When, for example, the second computer 60a informs the first computer 50 of a virus attack, the second computer 60a forwards a message containing the virus to the first computer 50. The first computer 50 can add this infected message to the categorization database 54 so that any future incoming messages that contain the identified virus will be properly classed as virus-containing messages; that is, they will have a high confidence score indicating that the message is a virus-containing message. Whether or not the first computer 50 adds the forwarded infected message to the categorization database will depend upon a user profile that is associated with the forwarded infected message.

In the first embodiment, the categorization database 54 contains a single sub-database 54a dedicated to the identification and definition of various known virus types 200. The format of the sub-database 54a will depend upon the type of classifier 53 used, and is beyond the scope of this invention. In any event, regardless of the methodology used for the classifier 53, the classifier 53 will make use of sample entries 200 in the sub-database 54a to generate the confidence score. By augmenting the sample entries 200 within the sub-database 54a it is possible to affect the confidence score; in effect, by adding sample entries 200, a type of machine learning is made possible to enable the first computer 50 to widen its virus catching net.

When analyzing the incoming message 74, it is possible for the classifier 53 to perform the classification confidence analysis on the entire message 74. However, with particular regard to e-mail, it is generally desirable to perform a separate analysis on each attachment contained within the e-mail message 74, and based upon the highest score obtained therefrom assign a total confidence score to the e-mail message 74. For example, the incoming message 74 may have a body portion 74a, two attachments 74b and 74c that are pictures, and an attachment 74d that contains an executable file. The classifier 53 may first consider the body 74a, classifying the body 74a against the virus sub-database 54a, to generate a score, such as 0.01. The classifier 53 would then separately consider the pictures 74b and 74c, classifying them against the virus sub-database 54a, perhaps to generate scores of 0.06 and 0.08, respectively. Finally, the classifier 53 would analyze the executable 74d in the same manner, perhaps obtaining a score of 0.88. The total confidence score for the incoming message 74 being classed as a virus-containing message would be taken from the highest score, yielding a classification confidence score of 0.88. This is just one possible method for assigning a classification confidence score to the incoming message 74. Exactly how one chooses to design the classifier 53 to assign a classification confidence score based upon message content and the sub-database 54a is actually a design choice for the engineer, and may vary depending upon the particular situations being designed for. With regards to this, it should be noted that it is possible, and perhaps desirable, to have the operation of the classifier 53 vary depending upon the type of attachment contained within the message 74. For example, the classifier 53 may use one scoring system methodology for a binary/executable attachment, another for a word processing document, and yet another for an HTML attachment. Doing so provides flexibility in identifying viruses in different attachment types, tailoring the pattern recognition code in the classifier 53 to specific class instances. Further, the classifier 53 need not come up with a single classification confidence score for the entire incoming message 74. Instead, the classifier 53 may provide a classification confidence score for each attachment within the incoming message 74. Doing so affords greater flexibility when determining how to process and filter the incoming message 74.

The first computer 50 contains a message server 55 that initially obtains the incoming message 74. Example of such servers include a Simple Mail Transfer Protocol (SMTP) daemon. The message server 55 caches the incoming message 74, and then the classifier 53 is instructed to perform a classification analysis of the incoming message 74, thereby generating a classification confidence score 56. As previously indicated, the confidence score 56 is generated by the classifier 53 based upon the virus definitions 200 found in the virus sub-database 54a. The message server 55 may instruct the classifier 53 to perform the classification analysis, or a separate control program may be used, such as a scheduling program or the like. For the first embodiment, it is assumed that the classification confidence score 56 includes a separate confidence score 56b, 56c, 56d for each attachment 74b, 74c, 74d, as well as one 56a for the body 74a of the message 74. The body 74a has a corresponding confidence score 56a, and in the above example this is a value of 0.01. The first attachment 74b has a corresponding confidence score 56b, and in the above example this is a value of 0.06. The second attachment 74c has a corresponding confidence score 56c of 0.08. Finally, the third attachment 74d gets a corresponding confidence score 56d of 0.88, which is rather high, indicating that the third attachment 74d has a high probability of containing a virus. The overall classification confidence score 56 can simply be assumed to be the highest value, which is the 0.88 obtained from the third attachment confidence score 56d. Of course, the number of attachment confidence scores 56b, 56c, etc. will directly depend upon the number of attachments 74b, 74c, etc. contained within the incoming message 74. The number of such scores can be zero or greater, as messages can contain zero or greater numbers of attachments.

After obtaining the confidence score 56 for the incoming message 74, a message filter 57 is then called to determine how to process the incoming message 74. The message filter 57 applies one of several filtering techniques based upon the confidence score 56. Examples of some of these techniques are briefly outlined. In the first and most drastic filtering technique, any confidence score 56 that exceeds a threshold value 57a will lead to the deletion of the associated incoming message 74. An operator of the computer 50 may set the threshold value 57a. For example, if the threshold value 57a is 0.80, and the overall confidence score 56 for the incoming message 74 is 0.88 as per the examples above, then the incoming message 74 would simply be deleted. Notification of such a deletion may be sent instead to the intended recipient 60a-60n of the incoming message 74. In effect, the incoming message 74 is replaced in totality by a notification message 57b, which is then passed to the intended recipient 60a-60n. A second alternative is simply to delete any attachment that exceeds the threshold limit 57a. In the above example, the body 74a and picture attachments 74b and 74c would not be deleted. The executable attachment 74d, however, would be stripped from the incoming message 74, as its corresponding score 56d of 0.88 exceeds the threshold value 57a of 0.80. The message filter 57 may optionally insert a flag into the modified incoming message 74 to indicate such deletion of the attachment 74d, or place a note into the body 74a. The incoming message 74, with any offending attachments 74d, etc. removed, and with optional indications thereof inserted, is then forwarded to the intended recipient 60a-60n. Finally, the most passive action of the message filter 57 is simply to insert warning indicators into the incoming message 74 for any attachment that is found to be suspicious. The warnings may be in the form of additional fields in the header of the incoming message 74, may be placed in the body 74a of the incoming message 74, or may involve altering the offending attachment (such as attachment 74d in the current example) in such a manner that an attempt on the part of the user to open the attachment (e.g. 74d) causes a warning message to appear that the user must first acknowledge prior to actually being able to open the attachment (e.g. 74d).

Each of the second computers 60a-60n is provided with a forwarding module 63. The forwarding module 63 is tied quite closely to the classifier 53, and is in networked communications with the classifier 53. In particular, the forwarding module 63 is capable of sending an update message 63a to the classifier 53, and associating the update message 63a with one of the categories in the categorization database 54. The update message 63a is also associated with a user that caused the update message 63a to be generated. In the first embodiment example, as the categorization database 54 has but one category, the virus sub-database 54a, association with the sub-database 54a is implicit. The update message 63a so sent is in result to a user of the second computer 60 identifying a virus from an incoming message. Association of the message 63a with the user of the second computer 60a-60n may also be implicit, as the second computers 60a-60n are clients of the server 50, and hence a login process is required. For example, to serve as a client 60a of the server 50, a user of the second computer 60a must first log into the first computer 50, in a manner well known in the art. Thereafter, any message 63a received by the server 50 from the second computer 60a is assumed to be from the user that logged the second computer 60a onto the server 50. Alternatively, the message 63a may explicitly carry user profile data 63b of the user that caused the message 63a to be generated. This user profile data 63b is typically a user ID value. The user is able to use the forwarding module 63 to forward an infected message to the classifier 53. The entire infected message may form the update message 63a, or only the infected attachment may form the update message 63a. As association of the update message 63a with the single sub-database 54a in the categorization database 54 is implicit, the association need not be explicitly contained within the update message 63a. The network connection 42 is then used to pass this update message 63a to the classifier 53. Upon reception of the update message 63a, the classifier 53 adds the update message 63a to the virus sub-database 54a as a new virus definition entry 200a if such a definition 200 is not already present, and if the user profile data 63b (explicitly or implicitly obtained) indicates that the user is a suitable source for a new sample entry 200a. Note that the meaning of “adding” such an entry may vary depending upon the methodology used for the classifier 53. It need not mean literally adding the contents of the update message 63a as a new entry 200a. For example, with vector-based pattern recognition and categorization, it may be the n-dimensional vector corresponding to the update message 63a that is added to the virus sub-database 54a as a new entry 200a. Other methods may require the actual data of the update message 63a to be entered in full as a new entry 200a; or only predetermined portions of the update message 63a. Exactly how this addition of a new entry 200a into the sub-database 54a is performed is a design choice based upon the type of classifier 53 used. However, the end result should be that an incoming message 74 that later arrives with such a virus should generate a high classification confidence score 56 as being a virus-containing message. How the user profile data 63b is used to determine addition of a new sample entry 200a will be discussed in more detail later.

To better understand the above, consider the following hypothetical scenario. The incoming message 74, with its associated attachments 74b, 74c and 74d, is received by the message server 55 and is destined for the second computer 60a. Assume that, as before, the threshold 57a is set to 0.80 for virus detection and elimination. Further assume that, in this case, the attachment 74d obtains a score 56d of 0.62, with all other attachments 74b and 74c scoring as in the above example. Thus, when scoring the third, executable attachment 74d against the current virus sub-database 54a, the executable attachment 74d obtains a score 56d of 0.62, which may be high, but which is not high enough to trigger an alarm by the message filter 57. Instead of deleting the executable attachment 74d, the message filter 57 may simply flag a warning that indicates the score 56d, and then send the so-augmented message 74 on to the second computer 60 (by way of the message server 55). At the second computer 60, a message server 65 receives the augmented message 74, and places it into a cache for perusal by a user. Later, a user utilizes a message reading program 64 to read the message 74 contained in the cache. In the course of opening the message 74, the message reading program 64 may indicate a warning in response to the inserted flag, such as, “Warning: The .EXE attachment “Hello, world!” contained in this message has a 62% chance of containing a virus.” At this point the user may opt to delete the attachment 74d, or to open it. Assume that the user chooses to open the executable attachment 74d. Further assume that this attachment contains a virus, which behaves in a manner that the user detects (perhaps by popping up unwanted messages, changing system settings without permission, sending off e-mails of itself to all people within the user's address book, etc). For the sake of convenience, the forwarding module 63 should interface with the message reading program 64 so that, from the point of view of the user, the two are part of the same program. The forwarding module 63 provides a user interface that enables the user to forward the offending attachment 74d to the first computer 50. Alternatively, if the user knows that a virus was contained within the message 74, but is unsure of which attachment 74b, 74c, 74d is responsible, the user may forward the entire message 74 to the first computer 50. In response to this action, the forwarding module 63 generates an appropriate update message 63a (i.e., the contents of the attachment 74d, or the entire message 74) and passes the update message 63a to the classifier 53 via the network connection 42. The classifier 53, associating the update message 63a with the “virus” category of the sub-database 54a (since this is the only category available), finds that the user profile data 63b indicates that the user is a valid source of virus data, and generates an entry based upon the update message 63a that is suitable to serve in the sub-database 54a. If this entry is not already present in the virus sub-database 54a, it is then added (for example, the “virus “x” definition” entry 200a). Some time later, be it seconds, hours or days, assume that a second incoming message 75 arrives from the Internet 70, destined for the second computer 60n. The second message 75, an e-mail, contains a body portion 75a and an executable attachment 75b, which also contains the virus that was found in attachment 74d of the first message 74. Upon reception, the second incoming message 75 is passed to the classifier 53, which generates a second classification confidence score 58. The score 58a for the body 75a is assumed to be 0.0. However, because of its extreme similarity to the attachment 74d, which subsequently obtained a corresponding entry 200a in the sub-database 54a, the executable attachment 75b obtains a corresponding score 58b of 0.95. This score 58b exceeds the threshold 57a, and so triggers an action from the message filter 57. The message filter 57 removes the attachment 75b, and then sends the augmented second message 75 on to the second computer 60n, perhaps with an added flag to indicate that the attachment 75b has been removed from the original second message 75. The message server 65 on the second computer 60n receives the augmented second message 75, and caches it. Later, when a user comes to view the second message 75, the message reading program 64 may inform the user that the attachment 75b has been deleted (as determined from the inserted flag), as with a message, “This message originally contained an “.EXE” attachment “Hello, world!” that has been removed due to virus infection.” The user of the second computer 60n is thus spared an infection by the virus that affected the user of the second computer 60a. Note that, in the above arrangement, when the first computer 50 is warned of a virus threat by any computer 60a-60n in the network 40, all computers in the network 40 are subsequently shielded from the virus. Hence, user knowledge of a new virus infection is leveraged to protect all users in the network 40.

Each of the second computers 60a-60n utilizes a forwarding module 63 to generate updates to the sub-database 54a. Hence, knowledge of virus infection by one user is leveraged to provide protection to all users. The means for providing this leverage is to make use of the classifier 53, rather than a standard anti-virus detection module. An anti-virus detection module is an all or nothing affair: it will say that a file is either infected, or is clean. The classifier is a bit more ambiguous, providing probabilities of infection, as provided by a classification confidence score, rather than a hard and fast infected/not infected answer. However, this ambiguity is also the source of a great deal of flexibility. Using the classifier 53 to generate a new entry 200a in the sub-database 54a based upon a virus report in the form of an update message 63a enables a form of machine learning, which rapidly and flexibly expands the scope of virus detection. As is well known, many viruses attempt to disguise themselves, adopting different guises and permutations. Nevertheless, different strains of such a virus may contain enough internal symmetries that allow them to be classified by a suitably designed classifier 53, from an entry 200 based upon just one originally identified strain. Furthermore, this updating process is effectively instantaneous. There is no need to wait for external support from an anti-virus vendor to aid in virus detection.

Another great advantage of utilizing a classifier is that the classifier is able to attempt to classify a message into any of one or more arbitrary categories. That is, the classifier is not limited to only attempting to find viruses. The classifier can also attempt to identify spam, pornography, or any other class that may be arbitrarily defined by a sub-database of example entries. In short, users in the network may indicate that a message contains a virus, spam, pornography or whatnot, forward such data to the classifier, and subsequent instances of such messages will be caught by the classifier and processed by the message filter. User knowledge in such a network is thus leveraged to detect not only viruses, but any sort of unwanted or undesirable message, or attachments in such messages.

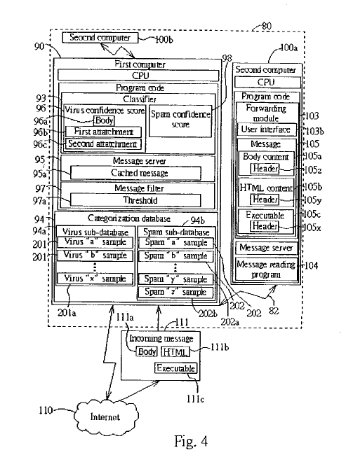

Please refer to FIG. 4. FIG. 4 is a simple block diagram of a network 80 according to a second embodiment of the present invention. By way of example, the second embodiment network 80 is designed to catch two classes of unwanted messages: those which are virus-containing, and those which are spam. Of course, the theory of operation is expandable to an arbitrary number of classes. Only two classes are discussed here for the sake of simplicity. In operation, the second embodiment network 80 is nearly identical to the first embodiment 40, except that on the first computer 90 the categorization database 94 is expanded to provide two sub-databases: a virus sub-database 94a, and a spam sub-database 94b. The classifier 93 is thus enabled to classify an incoming message against two distinct classes: a virus-containing class, as defined by the virus sub-database 94a, and a spam class, as defined by the spam sub-database 94b. As such, for each incoming message, the classifier 93 can provide two classification confidence scores: one classification confidence score 96 that indicates the probability that the incoming message belongs to the class of virus-containing messages, and another classification confidence score 98 indicating the probability that the incoming message belongs to the class of spam. The classification procedure employed by the classifier 93 should ideally be tailored to the particular class (i.e., particular sub-database 94a, 94b) that is being considered. For example, when determining the virus classification confidence score as determined by the virus sub-database 94a, the classifier 93 may check all attachments in an incoming message while ignoring the body of the message. However, when obtaining the spam classification confidence score as determined from the spam sub-database 94b, the classifier 93 may ignore the attachments in the incoming message (excepting HTML attachments), and only scan the body of the message. Hence, the mode of operation of the classifier 93 can change depending upon the type of classification analysis being performed to perform more accurate class-based pattern recognition.

Another difference exists on the second computers 100a, 100b with respect to the forwarding module 103. Only one second computer 100a is depicted in FIG. 4 with any detail, though the other second computer 100b also shares the functionality of the second computer 100a. When sending an update message 105 to the first computer 90 by way of the network connection 82, the forwarding module 103 must explicitly indicate the class (i.e., the sub-database 94a, 94b) with which the update message 105 is to be associated. In this manner, the classifier 93 can know into which sub-database 94a, 94b the entry corresponding to the update message 105 is to be placed as a new entry 201a, 202a, 202b. Exactly how the forwarding module 103 associates the update message 105 with a class is a design choice. For example, the update message 105 can include a header that indicates the associated class.

Consider the following example in which an incoming message 111 is received by the message server 95. The incoming message 111, an e-mail, includes a body 111a, an HTML attachment 111b and an executable attachment 111c. The classifier 93 generates two classification confidence scores: a virus classification confidence score 96, and a spam classification confidence score 98. The virus classification confidence score 96 contains a score 96a for the body 111a, a score 96b for the HTML attachment 111b, and a score 96c for the executable attachment 111c. The scores 96a, 96b and 96c are generated as in the first embodiment method, using sample entries 201 (including any new sample entries 201a) from the virus sub-database 94a as a classification basis. The spam classification confidence score 98 in this example is simply a single number, which thus indicates the probability of the entire message 111 being classed as spam. To generate the spam classification confidence score 98, the classifier 93 uses sample entries 202 in the spam sub-database 94b (including new sample entries 202a, 202b) as a classification basis. As an example, the classifier 93 may only scan the body 111a and the HTML attachment 111b to perform the spam classification analysis.

The action of the message filter 97 may depend upon the type of classification confidence score 96, 98 being considered. For example, when filtering the attachments 111b and 111c in the message 111 for viruses, which is based upon the corresponding confidence scores 96b and 96c in the virus classification confidence score 96, the message filter 97 may choose to delete any attachment 111b, 111c whose corresponding score 96b, 96c exceeds the threshold 97a, as described previously. Such aggressive active deletions ensure that the network 80 is kept free from virus threats, as the potential loss from virus attacks exceeds the inconvenience of losing a benign attachment that has been incorrectly categorized as a high-risk virus threat. However, when filtering for spam, which is based upon the spam classification confidence score 98, the message filter 97 may simply decide to insert a flag into the message 111 if the spam classification confidence score 98 exceeds the threshold 97a. Doing so prevents the unintentional deletion of useful messages that are erroneously categorized as being spam, which can occur if the message filter 97 employs aggressive active deletion. In short, exactly how the message filter 97 is to behave with regards to the classification confidence scores 96, 98 is a design choice. The incoming message 111, augmented by the message filter 97, is then forwarded to its intended recipient.

Suppose that the incoming message 111 is passed in its entirety to the second computer 100a. At the second computer 100a, a user utilizes a message reading program 104 to read the incoming message 111, and identifies it as a particularly nasty piece of spam with an embedded virus within the executable attachment 111c. Manipulating a user interface 103b of the forwarding module 103, which should ideally integrate seamlessly with the user interface of the message reading program 104, the user indicates to the forwarding module 103 that attachment 111c contains a virus, and that the entire message 111 is spam. In response, the forwarding module 103 generates an update message 105, which is then relayed to the classifier 93 via the network connection 82. The update message 105 contains the executable attachment 111c as executable content 105c, and associates the executable content with the virus sub-database 94a by way of a header 105x. The update message 105 also contains the body 111a as body content 105a, and the HTML attachment 111b as HTML content 105b, both of which are associated with the spam sub-database 94b by respective headers 105z and 105y. Upon receiving the update message 105, the classifier 93 updates the categorization database 94. The executable content 105c is used to generate a new sample entry 201a in the virus sub-database 94a. The body content 105a is used to generate a new sample entry 202b in the spam sub-database 94b. Similarly, the HTML content 105b is used to generate a new sample entry 202a in the spam sub-database 94b. These new sample entries 201a, 202a, 202b may be used to catch any future instances of the same spam and/or virus-laden executable 111c. Whether or not the new sample entries 201a, 202a, 202b are used in a subsequent classification process is discussed later.

Consider the situation, then, in which an identical instance of message 111 is sent to the network 80 from the Internet 110, destined for the second computer 100b, and all new sample entries 201a, 202a, 202b are used by the classifier 93. The knowledge leveraged from the user of the second computer 100a is used to protect the second computer 100b. With the updated sub-databases 94a and 94b, when the incoming message 111 is scanned to generate the classification confidence scores 96 and 98, the executable attachment score 96c will be very high (due to the new entry 201a), and the spam classification confidence score 98 will be very high as well (due to the new entries 202a and 202b). The executable attachment 111c will thus be deleted by the message filter 97, and a flag will be inserted into the message 111 indicating the probability (as obtained from the spam classification confidence score 98) of the message 111 being spam. When a user of the second computer 100b goes to read the incoming message 111 (as augmented by the message filter 97), he or she will be informed that (1) the message 111 has a high probability of being spam (because of the flag embedded within the augmented message 111), and (2) that the executable attachment 111c has been deleted due to detection of a virus threat.

Whenever the categorization database 94 is updated with new active (i.e., used) sample entries, all messages 95a cached by the message server 95 should once again be subjected to the classification and filtering regimen, utilizing the updated categorization database 94, to catch any potential spam or virus-containing messages that may have previously escaped detection. Also, it should be further noted that the number of classes against which an incoming message 111 may be classified is limited only by the abilities of the classifier 93. Each class simply has its corresponding sub-database that contains definition sample entries that define the scope of that class. Hence, it is possible to classify incoming messages 111 across numerous standards, and to filter them accordingly.

In a large networked environment, not all users may agree on how a particular message should be classified. For example, what one considers spam, another may consider informative. Without appropriate controls based upon a user profile, any user within the network 40, 80 can lead to the filtering of a message. This may not always be desirable. A single user, for example, may spuriously label legitimate e-mail as spam for no other reason than to disrupt the normal messaging abilities of the network 80. The following seeks to address this problem.

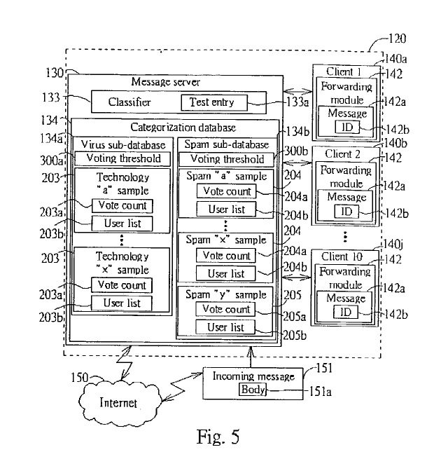

As a first solution, a sample entry in a sub-database is not enabled until a sufficient number of users agree that the sample entry properly belongs in the class corresponding to the sub-database. In effect, a voting procedure is provided, in which a sample entry is enabled only when a sufficient number of users agree that it is a proper sample entry. For example, in a network of seven users, four users must submit a particular message as spam before a sample entry for that message is entered into the spam sub-database. Please refer to FIG. 5. FIG. 5 is a block diagram illustrating the voting method of the present invention filtering system. A third embodiment network 120 of the present invention is nearly identical to the network 80, except that a voting scheme is clearly implemented, and the related classes are “spam” and “technology”. As such, only components that are necessary for understanding the voting scheme are included in FIG. 4. The network 120 includes a message server 130, which performs the categorization and filtering technique of the present invention, networked to ten client computers 140a-140j. Each client 140a-140j contains a forwarding module 142 of the present invention. When generating an update message 142a, the forwarding module 142 includes the user identification (ID) 142b of the user that is submitting the update message 142a to the server 130. This is explicit inclusion of the user profile (in the form of an ID value 142b) within the update message 142a, and is shown for the sake of clarity. Implicit inclusion of user profile data is possible as well, however, as the server 130 is capable of determining from which client 140a-140j an update message 142a is received, and hence which user is responsible for the update message 142a.

Within the categorization database 134, each sub-database 134a, 134b has a respective voting threshold 300a, 300b. Within the technology sub-database 134a, each technology sample entry 203 contains an associated vote count 203a and an associated user list 203b. The classifier 133 only uses an entry 203 in the virus sub-database 134a if the vote count 203a of the entry 203 meets or exceeds the voting threshold 300a. That is, such sample entries 203 become active. Similarly, within the spam sub-database 134b, each spam sample entry 204 contains an associated vote count 204a and an associated user list 204b. The classifier 133 only uses an entry 204 (the entry 204 becomes active) in the spam sub-database 134b if the associated vote count 204a of the entry 204 meets or exceeds the voting threshold 300b. When a forwarding module 142 submits an update message 142a to the classifier 133, the classifier 133 first generates a test entry 133a for each content block within the update message 142a. This is necessary for those types of classifiers 133 that employ processed data as sample entries 203, 204. For each test entry 133a, the classifier 133 then checks to see if the test entry 133a is already present as an entry 203, 204 in its associated sub-database 134a, 134b. If the test entry 133a is not present, then the test entry 133a is used as a new sample entry 203, 204 within its sub-database 134a, 134b. The vote count 203a, 204a for this new sample entry 203, 204 is set to one, and the user list 203b, 204b is set to the ID 142b obtained from the update message 142a. On the other hand, if the test entry 133a is already present as a definition 203, 204 in its associated sub-database 134a, 134b, the classifier 133 then checks the associated user list 203b, 204b of the sample entry 203, 204 for the ID 142b. If the ID 142b is not present, then it is added to the user list 203b, 204b, and the vote count 203a, 204a is incremented by one. If, however, the ID 142b is already present in the associated user list 203b, 204b, then the vote count 203a, 204a is not incremented. In this manner, a single user is prevented from casting more than one vote for a particular definition entry 203, 204. Note that under this scheme, the vote counts 203a, 204a are not explicitly needed, and can be obtained simply by counting the number of entries in the associated user list 203b, 204b. Many trivially different methods may be used to implement this voting scheme, and vote counts 203a, 204a are shown simply for the purpose of clarity. For example, rather than counting up to a threshold vote value 300a, 300b, one may instead count from a threshold value down to zero. Hence, it is not important that the vote count 203a, 204a exceed a threshold value per se, but rather that the vote count 203a, 204a reaches a threshold value. A sysop of the message server 130 is free to set the voting thresholds 300a and 300b as may be desired. For example, the spam voting threshold 300b may be set to five. In this case, at least five different users of the client computers 140a-140j must vote on the same message as being spam, by submitting appropriates update messages 142a, before the corresponding definition entry 204 becomes active in the spam sub-database 134b. This prevents a single user from causing an instance of a message from being blocked to all users. In effect, veto power of individual users is prevented, enforcing a group dynamic in which a predetermined number of users must agree that a certain instance of spam is to be blocked. On the other hand, suppose that the technology class is used by the server 130 filtering software to insert a “technology” flag into messages to alert users that the message relates to technology of interest to the group of users. In this case, the technology voting threshold 300a may be set to one. Any user may forward an article as “technology” related, and hence of interest, and any subsequent instances of such a message will be flagged by the server 130, after categorization, as “technology” for the informative benefit of other users. In both cases, for spam and technology classes, the addition of new sample entries 203, 204 provides the basis of machine learning so as to improve the overall behavior of the classifier 133.

Consider an incoming message 151 originating from a bulk mailer in the Internet 150, and destined for client computer 140a. It is assumed that the incoming message 151 generates low technology and spam classification confidence scores, and so passes on to the client 140a. Upon reading the incoming message 151, the client 140a tags it as spam, and uses the forwarding module 142 to generate an appropriate update message 142a. The update message 142a contains the body 151a of the incoming message 151 as content, the ID 142b of the user of the client computer 140a, and associates the content of the update message 142a with the spam sub-database 134b (say, by way of a header). The update message 142a is then relayed to the classifier 133. Utilizing the content of the update message 142a that contains the body 151a, the classifier 133 generates a test entry 133a that corresponds to the body 151a. The classifier 133 then scans the spam sub-database 134b for any sample entry 204 that matches the test entry 133a. None is found, and so the classifier 133 creates a new sample entry 205. The new sample entry 205 contains the test entry 133a as a definition for the body 151a, a vote count 205a of one, and a user list 205b set to the ID 142b contained within the update message 142a. At this time, assume that the spam voting threshold 300b is set to four. A bit later, an identical spam message 151 comes in from the Internet 150, this time destined for the second client computer 140b. The classifier 133 effectively ignores the new entry 205 until its vote count 205b equals or exceeds the voting threshold 300b. The new sample entry 205 is thus inactive. The spam message 151 is consequently sent on to the second client 140b without filtering, just as it did the first time, as there has been no real change to the rules used by the classifier 133 with respect to the spam sub-database 134. The second client also votes on the incoming message 151 as being spam, by way of the forwarding module 142. As a result, the vote count 205a increases to two, and the user list 205b includes the IDs 142b from the first client 140a and the second client 140b. Eventually, with enough voting on the part of users in the network 120, the vote count 205a equals the voting threshold 300b. The new entry 205 thus becomes an active sample entry, with a corresponding change to the classification rules. At this time, any messages queued in the server 130 should undergo another classification procedure utilizing the new classification rules. When another identical spam message 151 arrives, this time destined for the tenth client 140j, the incoming message 151 will generate a high score due to the new, active, sample entry 205, and thus be filtered accordingly. In short, any sub-database of the present invention may be thought of as being broken into two distinct portions: a first portion that contains active entries, and so is responsible for the categorization rules that are used to supply a confidence score; a second portion contains inactive entries that are not used to determine confidence scores, but which are awaiting further votes from users until their respective vote counts exceed a threshold and so graduate into the first portion as active entries.

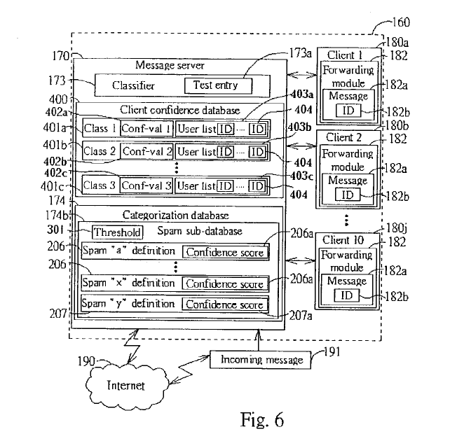

As a second solution, rather than providing voting, each user of the network can be assigned to one of several confidence classes, which are then used to determine if a submission should be active or inactive. This may be thought of as a weighted voting scheme, in which the votes of some users (users in a higher confidence class) are considered more important than the same votes by users in lower confidence classes. A user that is known to submit spurious entries can be assigned to a relatively low confidence class. More trustworthy users can be slotted into higher confidence classes. Please refer to FIG. 6. FIG. 6 is a simple block diagram of a network utilizing user classes according to the present invention. A network 160 is much like those of the previous embodiments. For the sake of simplicity, only a single classification, spam, with associated sub-database 174b, is shown. As before, a client/server arrangement is shown, with a message server 170 networked to a plurality of client computers 180a-180j. In addition to a classifier 173 and a categorization database 174, the message server 170 also includes a user confidence database 400, which contains a number of confidence classes 401a-401c. The number of confidence classes 401a-401c, and their respective characteristics, may be set, for example, by the administrator of the message server 170. As a specific example, three confidence classes 401a-401c are shown. Each confidence class 401a-401c contains a respective confidence value 402a-402c, and a respective user list 403a-403c. Each user list 403a-403c contains one or more user IDs 404. A user of one of the client computers 180a-180j whose ID 182b is within a user list 403a-403c is said to belong to the class 401a-401c associated with the list 403a-403c. The associated confidence value 402a-402c indicates the confidence given to any submission provided by that user. Higher confidence values 402a-402c indicate users of greater reliability. To provide a submission to the categorization database 174, a user should be present in one of the user lists 403a-403c so that an appropriate confidence value 402a-402c can be associated with the user. Each inactive sample entry 206 within the spam sub-database 174b has an associated confidence score 206a. The confidence score 206a is a value that indicates the confidence that the sample entry 206 actually belongs to the spam sub-database 174b. Those sample entries 206 having confidence scores 206a that exceed a threshold 301 become active entries, and are then used to generate the classification rules. Those sample entries 206 whose confidence scores 206a are below the threshold 301 remain inactive entries, and are not used by the classifier 173. In general, each confidence score 206a may be thought of as a nested vector, having the form:

<(n₁, Class1_{conf}_{_{—}}ᵥₐₗ, Msg_{conf}_{_{—}}ᵥₐₗ₁),
(n₂, Class2_{conf}_{_{—}}ᵥₐₗ, Msg_{conf}_{_{—}}ᵥₐₗ₂),
.
.
.
(nᵢ, Classi_{conf}_{_{—}}ᵥₐₗ, Msg_{conf}_{_{—}}ᵥₐₗᵢ)>

In the above, “n” indicates the number of users in the particular class that submitted the entry. For example, for a sample entry 206, “n₁” indicates the number of user in class1 401a that submitted the entry 206 as a spam sample entry. The term “Class_{conf—val}” is simply the confidence value for that class of users. For example, “Class1_{conf—val}” is the class1 confidence value 402a. The term “Msg_{conf—val}” indicates the confidence score of that class of users for the message 206. For example, “Msg_{conf—val1}” indicates the confidence, as provided by users in class1 401a, that the sample entry 206 belongs in the spam sub-database 174b. The total confidence score, assuming that there are “i” user classes in the client confidence database 400, is given by:

$$Total confidence score = {\sum }_{x - 1}^{i} ( {ClassK}_{Conf\_vol} ) ( {Msg}_{Conf\_volK} ) \qquad ( Eqn . 1 )$$

If the total confidence score of a confidence vector 206a for an entry 206 exceeds the threshold 301, then that entry 206 becomes an active entry 206, and is used to generate the classification rules that are applied when generating a classification confidence score for a message by the classifier 173. Otherwise, the sample entry 206 is assumed to be inactive, and is not used by the classifier 173 when generating a spam classification confidence score.

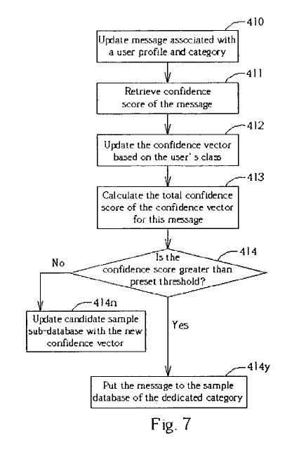

Please refer to FIG. 7 with reference to FIG. 6. FIG. 7 is a flow chart describing modification to the spam sub-database 174b according to the present invention. The steps are described in more detail in the following.

410:

A forwarding module 182 on one of the clients 180a-180j composes a update message 182a, and delivers the update message 182a to the message server 170. The update message 182a will include the ID 182b of the user that caused the update message 182a to be generated, and indicates the sub-database for which the update message 182a is intended; in this case, the spam sub-database 174b is the associated sub-database.

411:

The message server 170 utilizes the ID 182b within the update message 182a, and scans the IDs 404 within the user lists 403a-403c for a match. The class 401a-401c that contains an ID 404 that matches the message user profile ID 182b is then assumed to be the class 401a-401c of the user that sent the update message 182a, and the corresponding class confidence value 402a-402c is obtained. Based upon the contents of the update message 182a, the classifier 173 generates a corresponding test entry 173a, and searches for the test entry 173a in the spam sub-database 174b. For the present invention embodiment, it is only necessary to search inactive entries 206. Hence, it may be desirable to break the sub-database 174b into two distinct portions: one containing only active entries 206, and another containing only inactive entries 206. Only the portion containing the inactive entries 206 needs to be searched. Although all sample entries 206 in FIG. 6 are shown with confidence score vectors 206a, it should be understood that, for the preferred embodiment, the active entries 206 do not need such confidence vectors 206a. This can help to reduce memory usage in the categorization database 174. If no entry 206 is found that corresponds to the test entry 173a, then a new entry 207 is generated, which corresponds to the test entry 173a. The confidence score 207a of such a new entry 207 is set to a default value, given as:

<(0, Class1_{Conf}_{_{—}}ᵥₐₗ, 0),
(0, Class2_{Conf}_{_{—}}ᵥₐₗ, 0),
.
.
.
(0, Classi_{Conf}_{_{—}}ᵥₐₗ, 0)>

That is, within the confidence vector 207a, all user class counts “n” are set to zero, and all class confidence scores are set to zero.

412:

The confidence score 206a/207a found/created in step 411 is calculated according to the user class 401a-401c and associated class confidence value 402a-402c, which were also found in step 411. Many methods may be employed to update the confidence vector 206a/207a; in particular, Bayes rule, or other well-known pattern classification algorithms, may be used.

413:

The total confidence score for the confidence vector calculated in step 412 is calculated according to Eqn.1 above.

414:

Compare the total confidence score computed in step 413 with the threshold value for the associated sub-database (i.e., the threshold value 301 of the spam sub-database 174b). If the total confidence score meets or exceeds the threshold value 301, then proceed to step 414y. Otherwise, go to step 414n.

414n:

The entry 206/207 found/created in step 411 is an inactive entry 206/207, and so the categorization rules for the sub-database 174b remain unchanged. Update the confidence vector 206a/207a for the entry 206/207 with the value computed in step 412. Categorization as performed by the classifier 173 continues as before, and is functionally unaffected by the update message 182a of step 410.

414y:

The entry 206/207 found/created in step 411 is an active entry 206/207, and is updated to reflect as such. For example, the entry 206/207 is shifted into the active portion of the sub-database 174b, and its associated confidence vector 206a/207a can therefore be dropped. The categorization rules for the associated sub-database 174b must be updated accordingly. Categorization as performed by the classifier 173 is potentially affected, with regards to the associated sub-database 174b in which the entry 206/207 has become an active entry, by the update message 182a of step 410. Any queued messages on the message server 170 should be re-categorized with respect to the category corresponding to the associated sub-database 174b.

To better understand step 412 above, consider the following specific example. Assume that there are ten users, which are partitioned into four classes class1-class4 with respective Classconf_valvalues of (0.9, 0.7, 0.4, 0.1). When a new message comes in, the following example steps occur that finally determine if this message belongs to a specific category, such as the spam category. It is assumed that the threshold 301 for this specific category is 0.7.

Step 0:

The initial confidence score 206a/207a for the new message is <(0,0.9,0), (0,0.7,0),(0,0.4,0),(0,0.1,0)>.

Step 1:

A user in class1 votesfor the message being in the specific category and the confidence score 206a/207a for the message becomes: <(1,0.9,1),(0,0.7,0),(0,0.4,0), (0,0.1,0)>.

Step 2:

A user in class2 votes for the message being in the specific category and the confidence score 206a/207a for the message becomes: <(1,0.9,1/2),(1,0.7,1/2), (0,0.4,0),(0,0.1,0)>

Step 3:

A user in class2 votes for the message being in the specific category and the confidence score 206a/207a for the message becomes: <(1,0.9,1/3),(2,0.7,2/3), (0,0.4,0),(0,0.1,0)>

Step 4:

A user in class4 votes for the message being in the specific category and the confidence score 206a/207a for the message becomes: <(1,0.9,1/4),(2,0.7,2/4), (0,0.4,0),(1,0.1,1/4)>

Step 5:

A user in class1 votes for the message being in the specific category and the confidence score 206a/207a for the message becomes: <(2,0.9,2/5),(2,0.7,2/5), (0,0.4,0),(1,0.1,1/5)>

Step 6:

A user in class2 votes for the message being in the specific category and the confidence score 206a/207a for the message becomes: <(2,0.9,2/6),(3,0.7,3/6), (0,0.4,0),(1,0.1,1/6)>

Step 7:

A user in class1 votes for the message being in the specific category and the confidence score 206a/207a for the message becomes: <(3,0.9,3/7),(3,0.7,3/7), (0,0.4,0),(1,0.1,1/7)>

Step 8:

A user in class4 votes for the message being in the specific category and the confidence score 206a/207a for the message becomes: <(3,0.9,3/8),(3,0.7,3/8), (0,0.4,0),(2,0.1,2/8)>

Step 9:

A user in class1 votes for the message being in the specific category and the confidence score 206a/207a for the message becomes: <(4,0.9,4/9),(3,0.7,2/9), (0,0.4,0),(2,0.1,2/9)>

Step 10:

A user in class3 votes for the message being in the specific category and the confidence score 206a/207a for the message becomes: <(4,0.9,4/10),(3,0.7,3/10), (1,0.4,1/10),(2,0.1,2/10)>

Step 10:

The value for the total confidence score 206a/207a is calculated as: (0.9×0.4)+(0.7×0.3)+(0.4×0.1)+(0.1×0.2)=0.73.

Step 11:

After comparing the calculated confidence score of 0.73 with the categorys threshold 310 of 0.7, the system determines that the new message belongs to the specific category, and the entry associated with this new message becomes an active entry.

Confidence scoring, as indicated in the above second solution, and voting as indicated in the first solution, can be selectively implemented on any sub-database. Confidence scoring could be used on one sub-database, while voting is used on another. Moreover, a combined confidence and voting technique could be used. That is, a definition entry would only become active once its vote count exceeded a voting threshold, and the total confidence score of its confidence vector also exceeded an associated threshold value. In a similar vein, it should be noted that the message filter is not restricted to a single threshold value. The message filter may apply different threshold values to different sub-databases. Moreover, the filtering threshold value itself need not be a single value. The filtering threshold value could have several values, each indicating a range of classification confidence scores. Each range could then be treated in a different manner. For example, when filtering spam, a filtering threshold value might include a first value of 0.5, indicating that all spam classification confidence values from 0.0 to 0.50 are to undergo minimal filtering (e.g., no filtering at all). A second value of 0.9 might indicate that spam classification confidence values from 0.50 to 0.90 are to be more stringently filtered (e.g., a flag indicating the confidence value is inserted into the message to alert the recipient). Anything scoring higher than 0.90 could be actively deleted.

Block diagrams in the various figures have been drawn in a simplistic manner that is not intended to strictly determine the layout of components, but only to indicate the functional inter-relationships of the components. For example, it is not necessary for the categorization database to contain all of its sub-databases within the same file structure. On the contrary, the categorization database could be spread out across numerous files, or even located on another computer and accessed via the network. The same is also true of the various modules that make up the program code on any of the computers.

In contrast to the prior art, the present invention provides a classification system that can be updated by users within a network. In this manner, the pattern recognizing abilities of a message classifier are leveraged by user knowledge within the network. The present invention provides users with forwarding modules that enable them to forward a message to another computer, and to indicate a class within which that message belongs (such as spam, virus-containing, etc.). The computer receiving such forwards updates the appropriate sub-database corresponding to that class so as to be able to identify future instances of similar messages. Moreover, the present invention provides certain mechanisms to curtail abuse that may result from users spuriously forwarding messages to the server, which could adversely affect the categorization scoring procedure. These mechanisms include a voting mechanism and user confidence tracking. In the first, a minimum number of users must agree that a particular message properly belongs to an indicated class before that message is actually admitted into that class as a basis for filtering future instances of such messages. In the second, each user is ranked by a confidence score that indicates a perceived reliability of that user. Each entry in a sub-database has a confidence score that corresponds to the reliability of the users that submitted the entry. When entries exceed a confidence threshold, they are then used as active entries to perform categorization.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for leveraging user knowledge for categorization of messages in a computer network, the computer network comprising a first computer in networked communications with a plurality of second computers, the method comprising:
providing the first computer with a classifier capable of assigning a classification confidence score to a message for at least a category;
providing the first computer with a categorization database that contains a category sub-database for each category; wherein the classifier utilizes the category database to assign the classification confidence score;
providing each of the second computers with a forwarding module capable of sending a message from the second computer to the first computer and associating the message with at least one of the categories in the categorization database and associating the message with a user profile;
receiving a first message at any of the second computers;
utilizing the forwarding module at which the first message was received to generate and forward a second message to the first computer, contents of the second message based upon contents of the first message, the second message associated with a first category and a first user profile; and
modifying a first category sub-database in the categorization database according to the contents of the second message and the first user profile, the first category sub-database corresponding to the first category.

2. The method of claim 1 wherein modifying the first category sub-database includes generating a message sample entry in the first category sub-database corresponding to the contents of the second message.

3. The method of claim 1 wherein modifying the first category sub-database includes modifying a count entry of a message sample entry according to the first user profile; wherein the count entry indicates the number of users that submitted content corresponding to the content of the second message.

4. The method of claim 3 further comprising:
receiving a third message at the first computer; and
utilizing the classifier to obtain a classification confidence score for the third message, the classifier utilizing only sample entries that have an associated count value that reaches a predetermined threshold value to perform the classification analysis.

5. The method of claim 4 further comprising applying a filtering technique to the third message according to the classification confidence score.

6. The method of claim 1 further comprising:
obtaining a confidence score of a message sample entry that corresponds to the contents of the second message;
modifying the confidence score according to the first user profile; and
causing the message sample entry to be an active sample entry according to the modified confidence score and a threshold value.

7. The method of claim 6 further comprising:
receiving a third message at the first computer; and
utilizing the classifier to obtain a classification confidence score for the third message, the classifier utilizing only active sample entries.

8. The method of claim 7 further comprising applying a filtering technique to the third message according to the classification confidence score.

9. The method of claim 1 further comprising:
utilizing the classifier to respectively assign new classification confidence scores to all pending messages on the first computer after the modification of the first category sub-database in the categorization database; and
applying a filtering technique to all of the pending messages according to the respective new classification confidence scores.

10. The method of claim 1 wherein the first computer is a message server and the second computers are client computers of the message server.

11. A computer readable media containing program code for implementing the method of claim 1.

12. A computer network comprising:
a first computer; and
a plurality of second computers networked to the first computer;
wherein the first computer comprises:
a classifier capable of assigning a classification confidence score to a message for at least a category defined by a categorization database that contains a category sub-database for each category, the classifier capable of utilizing the category database to assign the classification confidence score to the message;
means for receiving an update message associated with a first category from any of the second computers; and
means for modifying a first category sub-database in the categorization database according to the update message and a user profile associated with the update message, the first category sub-database corresponding to the first category; and
the second computers each comprise:
means for receiving a first message; and
means for sending a second message to the first computer and associating the second message with at least one of the categories in the categorization database and a corresponding user profile, contents of the second message based upon contents of the first message.

13. The computer network of claim 12 wherein the means for modifying the first category sub-database is capable of generating a message sample entry in the first category sub-database corresponding to the received update message.

14. The computer network of claim 12 wherein the means for modifying the first category sub-database is capable of modifying a count entry corresponding to the received update message according to the user profile associated with the received update message; wherein the count entry indicates the number of users that submitted content corresponding to content of the received update message.

15. The computer network of claim 14 wherein the first computer further comprises:
means for receiving a third message from the network; and
means for utilizing the classifier to assign a classification confidence score to the third message;
wherein the classifier utilizes only sample entries that have an associated count value that reaches a predetermined threshold value to perform the classification analysis.

16. The computer network of claim 15 wherein the first computer further comprises means for applying a filtering technique to the third message according to the classification confidence score.

17. The computer network of claim 12 wherein the first computer further comprises:
means for obtaining a confidence score of a message sample entry that corresponds to the received update message;
means for modifying the confidence score according to the user profile associated with the received update message; and
means for causing the message sample entry to be an active sample entry according to the modified confidence score and a threshold value.

18. The computer network of claim 17 wherein the first computer further comprises:
means for receiving a third message from the network; and
means for utilizing the classifier to obtain a classification confidence score for the third message, the classifier utilizing only active sample entries.

19. The computer network of claim 18 wherein the first computer further comprises means for applying a filtering technique to the third message according to the classification confidence score.

20. The computer network of claim 1 2 wherein the first computer further comprises:
means for utilizing the classifier to respectively assign new classification confidence scores to all pending messages on the first computer after the modification of the first category sub-database in the categorization database according to the received update message; and
means for applying a filtering technique to all of the pending messages according to the respective new confidence scores.

21. The computer network of claim 12 wherein the first computer is a message server and the second computers are client computers of the message server.
